(19) United States
(12) Patent Application Publication
(10) Pub. No.: US 2008/0313639 A1
(43) Pub. Date: Dec. 18, 2008

(54) POLICY BASED SCHEDULING OF SOFTWARE APPLICATIONS

(76) Inventors: KRISHNA KUMAR, Chennai (IN); Murali Krishna, Bangalore (IN); Thiruvalluvan M.G., Chennai (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/762,708

(22) Filed: Jun. 13, 2007

(51) Int. Cl. G06F 9/50

(52) U.S. Cl. 718/104

(57) ABSTRACT

A method and apparatus for using policies to limit resource usage by software applications is disclosed herein. The policies define rules that specify a maximum amount of a resource that a particular application is allowed to use given the current state of the computer system, in one embodiment. The state can be defined based on conditions such as user activity, resource usage, time of day, etc. A scheduler monitors the computer system and the application and enforces the policies to control the resource usage of each application. If the scheduler determines that an application has been using more of a particular resource than is allowed then the scheduler takes some action to reduce resource usage until actual resource usage is at or below allowed resource usage. Each application has its own set of policies associated that allow the application to define rules to limit resource usage, in one embodiment.

### FIELD OF THE INVENTION

The present invention relates to scheduling processes in a computer system. In particular, embodiments of the present invention relate to using policies to limit resource usage.

### BACKGROUND

Scheduling software to run in a computer system involves determining when to allow each process or thread to have access to the processor or other resource. One scheduling scheme is to divide processor usage into relatively small time increments that are sometimes referred to as “time slices” with respect to CPU usage or “quotas” with respect to storage space. For example, each process (or thread) is allotted one or more time slices in which to execute. Numerous schemes have been developed to determine how often a process should be granted a time slice in which to execute. For example, some techniques allocate the processor on a substantially equal basis such that each process gets about the same amount of processor time. Another technique is to allocate more processor time to processes that have a higher priority. Still other techniques are to boost the priority or increase the time slice based on a variety of factors.

While such techniques are quite effective for many circumstances, these techniques may cause problems in some situations. For example, running a background application such as a desktop search engine indexer, disk defragmenter, or virus detection program may interfere with other applications such as word processors or e-mail programs. As a particular example, if a virus detection program is running in the background, the user may notice that a word processing program responds more slowly than normal.

Thus, improved software scheduling techniques are desired. Furthermore, improved techniques are desired for scheduling background applications such as virus detection programs, disk defragmenters, and desktop search engine indexes.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a system for controlling resource usage based on policies, in accordance with an embodiment of the present invention.

FIG. 2 is a flowchart of a procedure for policy based resource allocation, in accordance with an embodiment of the present invention.

FIG. 3 is a diagram of an example computer system in which embodiments of the present invention may be practiced.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Using policies to limit resource usage by software applications is disclosed herein. The policies define rules that specify a maximum amount of a resource that a particular application is allowed to use given the current state of the computer system, in one embodiment. The state can be defined based on conditions such as user activity, resource usage, time of day, etc. For example, one of the policies might dictate that an indexing engine running on a desktop be limited to little or no resource usage when there is a user interacting with the system. As another example, a set of policies might cause a disk defragmentation daemon to run at a low priority immediately after a full scan that yielded little benefit, but may increase the priority if disk activity increases.

A scheduler monitors the computer system and the application and enforces the policies to control the resource usage of each application. If the scheduler determines that an application has been using more of a particular resource than is allowed then the scheduler takes some action to reduce resource usage until actual resource usage is at or below allowed resource usage. For example, the scheduler might lower the scheduling priority of a process or thread associated with the application. As another example, the scheduler might temporarily suspend a process or thread associated with the application. Many other techniques are possible.

Each application has its own set of associated policies that allow the application to define rules that limit resource usage, in one embodiment. While not limited to background applications, policy based limiting of resource usage is suited for background applications such as anti-virus scanners, disk archival, defragmentation and compaction tools, and desktop indexing engines, which continuously run in the background, usually as daemons or services.

Limiting resource usage may have beneficial side-effects. For instance, limiting CPU usage may also limit the number of pages of memory of other applications that get swapped out. The policies may dictate that, even when there currently are no other consumers of a resource, the application still limits its resource usage, which can provide a variety of benefits. For example, full resource usage may cause continuous power consumption, excess heat, wear-and-tear, and a perception of inefficiency or software problems.

### System Overview

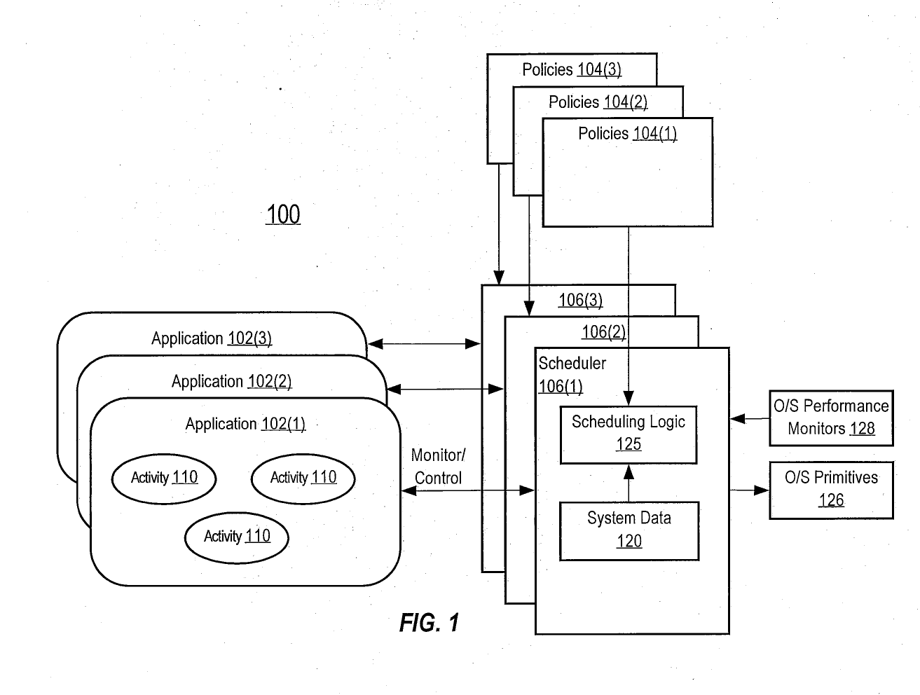

FIG. 1 depicts a system 100 for controlling resource usage of software applications based on policies 104, in accordance with an embodiment of the present invention. Each of the applications 102(1)-102(3) has a set of policies 104(1)-104(3) associated therewith. The policies 104 define an upper limit on resource usage for different states of the computer system, in one embodiment. The policies 104 may be stored, for example, in a system configuration file. Example policies 104 are discussed below. A scheduler 106 monitors to collect information to determine the state, as well as application resource usage. The scheduler 106 controls the resource usage of the applications 102, based on the policies 104. In one embodiment, there is an instance of a scheduler 106(1)-106(3) for each application 102(1)-102(3). However, in another embodiment a scheduler 106 controls more than a single application 102.

An application 102 is modeled as a set of activities 110, in one embodiment. The resource usage of the application 102 is controlled by controlling the resource usage of individual activities 110, in an embodiment of the present invention. For example, if the entire application 102 is allotted 30% CPU usage, then controlling each of three activities 110 to limit them to 10% CPU usage successfully limits the application 102 as a whole. However, it is not required that each activity 110 be limited to a particular resource usage limit in order to limit the application 102 as a whole.

The activities 110 may be implemented as separate processes, or threads within a process, or tasks serviced by a thread, or some combination thereof. Thus, as used herein, the term “activity” used in the context of a software application 102 includes a process, thread, or any combination of processes and threads. An application 102 may have any number of activities 110, including a single activity 110. As an example, an indexing engine could have a “crawling activity” that locates documents that have been changed recently, a “parsing activity” that parses the documents to extract keywords and create a rough index, and an “indexing activity” that refines the rough index to create a refined index that is suitable for querying.

In one embodiment, the scheduler 106 controls each activity's 110 resource usage based on an urgency of each activity 110. An urgency defines a measure of how important it is to schedule an activity 110 relative to other activities 110. An urgency is similar to a scheduling priority, but is not necessarily the priority that an operating system uses to schedule a particular process or thread. For example, the urgency that is assigned to an activity 110 does not necessarily correspond to the process priority it has if one were to view the process priority with a tool such as a task manager in the Windows® operating system. Each activity 110 has a separate value of its current “urgency,” in an embodiment. The activity 110 can alter its urgency based on factors such as the amount of work that the activity 110 needs to complete and the negative impact on the users or other applications 102 if the work is deferred. In one embodiment, each activity 110 proactively provides its urgency to the scheduler 106. In another embodiment, the scheduler 106 requests that the activity 110 provide its urgency. Thus, various techniques for the scheduler 106 to learn the urgency include, but are not limited to polling, notifications to the scheduler 106, and including the urgency in a scheduling request.

The scheduler 106 monitors conditions in the computer system to determine the state the computer system is in, as defined by the policies 104 for each application 102. Thus, given a current set of conditions, the state can be different for each application 102. For example, based on current conditions, the policies 104 might indicate that the computer system is in an “IDLE” state for a CPU intensive application 102, but is in a “BUSY” state for a network I/O intensive application 102.

The scheduler 106 stores information relating to the conditions in the system data 120, along with other information. The other information may include the applications' past resource usage, the total resource usage by all processes in the computer system, each activities' urgency, and information relating to the conditions for which the scheduler 106 monitored.

Based on the policies 104 and the system data 120, the scheduling logic 125 determines how to control the applications' usage of resources. To control a particular applications' 102(1) usage of a particular resource, the scheduling logic 125 determines a maximum usage, and then determines whether to perform an action to reduce the actual usage of the particular resource by the activities 110 of the application 102(1). As previously mentioned, various techniques are disclosed herein for reducing resource usage to enforce the policies 104.

The scheduler 106 resides outside of the operating system, in the embodiment depicted in system 100. In this embodiment, Each of the schedulers 106(1)-106(3) may use operating system performance monitors 128 to learn of the resource usage of the applications 102, as well as total system resource usage. Each scheduler 106(1)-106(3) may use operating system primitives 126 to control its respective application 102(1)-102(3). Alternatively, the scheduler 106 interfaces with its application 102 to monitor and control it. In another embodiment, the scheduler 106 resides in the operating system.

### Modes of Operation—Overview

The scheduler 106 may control resource usage of the applications 102 in either a collaborative mode or in a non-collaborative mode. In the collaborative mode, an activity 110 explicitly asks the scheduler 106 for permission to execute. For example, an activity 110 makes a call to the scheduler 106 via an API in order to request permission to execute. The call may also specify the activity's urgency and also possibly the activity's resource usage. The scheduler 106 determines when the activity 110 may execute in order to enforce the policy 104.

In the non-collaborative mode, the activities 110 do not need to have knowledge of the scheduler 106. In other words, the activities 110 do not request permission from the scheduler 106 to run. If the application 102 or activity 110 exceeds its resource limit, the scheduler 106 takes an action to “pre-empt” the activity 110. The scheduler 106 can use operating system primitives 126 in order control the activities 110. For example, if the activity 110, or its associated application 102, is utilizing too much of the resource, then the scheduler 106 might request the O/S to change the scheduling priority of one or more activities 110 of the application 102. In the non-collaborative mode, the scheduler 106 may use means such as operating system performance monitors 128 to learn of the resource usage of the applications 102, as well as total system resource usage.

Additional examples of controlling the applications 102 in the collaborative and non-collaborative mode are discussed below.

### Example Policies for Policy Based Resource Allocation

Table I-Table III depict example policies 104 for controlling resource allocation, in accordance with an embodiment. The policies 104 for each application 102 are based on “conditions” of the computer system, in this embodiment. The conditions define the “state”, in this embodiment. Based on the state, the application 102 is allowed a maximum resource usage. As will be discussed below, the maximum is scaled back, in one embodiment.

TABLE I
INDEXING_ENGINE_POLICY

| Condition | State | Limits |
|---|---|---|
| User active in the system in | USER_BUSY | CPU <5% |
| the last 60 seconds | | ResidentMemory <5% |
| User-triggered processes | SYSTEM_BUSY | CPU <10% |
| using CPU >60% | | ResidentMemory <10% |
| — | IDLE | CPU <50% |
| | | ResidentMemory <20% |

As an example, the policies 104 in Table I for the indexing engine dictate that if there is user activity within the last 60 seconds, then the state is “USER_BUSY”. In this state, CPU usage is limited to no more than 5% and resident memory is limited to no more than 5%. Note that the indexing engine does not attempt to use as much of a given resource that is available. For example, in the IDLE state, CPU usage is limited to no more than 50%. Thus, if the user pulls up a window such as a “task manager” window that is available in various versions of the Windows® operating system, the user will see that the CPU usage is no more than 50%. If the policies 104 did not limit the resource usage, then the indexing engine might use 100% of the CPU, which could give the user the impression that the indexing engine is monopolizing resources.

Also, if there are other applications 102 running simultaneously with the indexing engine, then limiting resources used by the indexing engine can help the other applications 102 run more smoothly. For example, if the user is playing a movie, the state might be “SYSTEM_BUSY”, in which case the policy 104 dictates that the indexing engine be limited to 10% CPU usage. Note that this state corresponds to greater than 60% CPU usage. Therefore, there could be up to 40% CPU usage available. However, the policies 104 limit the indexing engine to 10% CPU usage.

The rules for the policies 104 may be provided by the application 102. However, the rules may have user definable parameters. For example, the application 102 program can define a rule that states that if there is user activity within the last “n” seconds, then the CPU usage is to be limited to “x” percent. The user may specify the values for “n” and x Alternatively, the user might specify relative terms such as long, medium, short, or alternatively high, medium, and low, which are converted to numeric values for “n” and “x”.

Table II shows example policies 104 for a defragmenter engine, in accordance with an embodiment. Table III shows example policies 104 for a download engine, in accordance with an embodiment. Note that each application 102 is able to define its own set of states and the condition associated with the state. Also, the particular resource whose usage is being limited is application 102 specific.

TABLE II
DEFRAGMENTER_ENGINE_POLICY

| Condition | State | Limits |
|---|---|---|
| DBMS report | SYSTEM_BUSY | CPU <5% |
| processes running | | ResidentMemory <5% |
| Free disk space <5% | DISK_SPACE_LOW | — |
| — | IDLE | CPU <10% |
| | | ResidentMemory <20% |

TABLE III
DOWNLOAD_ENGINE_POLICY

| Condition | State | Limits |
|---|---|---|
| User active in the system in | USER_BUSY | Internet connection <5% |
| the last 60 seconds | | |
| 10:00 PM–06:00 AM | OFF_HOURS | — |
| — | IDLE | Internet connection <20% |

### Example Procedure for Policy Based Resource Allocation

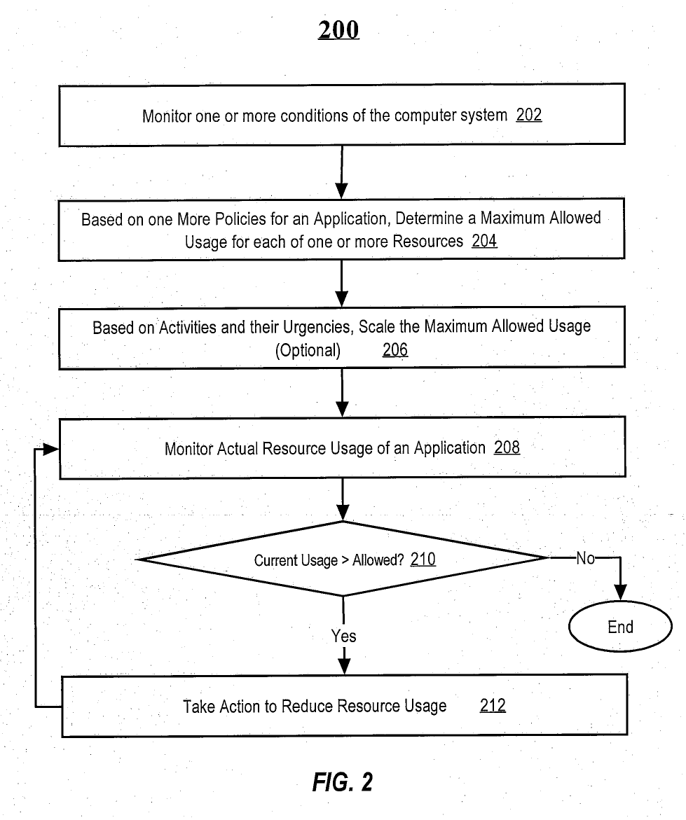

FIG. 2 is a flowchart of a procedure 200 for policy 104 based resource allocation, in accordance with an embodiment of the present invention. Procedure 200 will be discussed using the example system 100 of FIG. 1; however, procedure 200 is not limited to system 100. It will be appreciated that the steps of procedure 200 are ordered for convenience of explanation. In step 202, the scheduler 106 monitors one or more conditions of the computer system. Tables I-III provide some example conditions.

In step 204, the scheduler 106 determines a maximum resource usage for the application 102 based on one or more policies 104, as well as the conditions. As an example, the scheduler 106 determines that the indexing engine is allowed a maximum of 50% CPU usage because the conditions indicate that the computer system is in an IDLE state.

In optional step 206, the scheduler 106 scales down the maximum allowed resource usage based on the activities 110 that are currently running in the application 102 and their respective urgencies. For example, if the indexing engine has only one activity 110 running and it has a low urgency, then the scheduler 106 might scale the allowed CPU usage from 50% down to 10%. As a more particular example, the activity 110 of crawling to locate documents might have a low urgency. If this is the only activity 110 of the indexing engine, the CPU usage can be scaled down while still providing plenty of CPU resource for the crawling activity 110. Further details of scaling resource usage are discussed below.

Note that steps 202, 204, 206 may be performed repeatedly at any time that the application 102 is running.

In step 208, the scheduler 106 learns the actual resource usage of the application 102 to be scheduled. For example, the scheduler 106 learns the CPU usage over the last “x” seconds. As used herein, this time period will be referred to as a “monitor window”. In one embodiment, the application 102 reports its resource usage to the scheduler 106. In another embodiment, the scheduler 106 uses operating system performance monitors 128 to determine actual resource usage

In step 210, the scheduler 106 determines whether the actual resource usage of the application 102 exceeds the maximum allowed resource usage as determined by step 204 or step 206 if scaling was used. If resource usage is too high, then in step 212 the scheduler 106 takes an action to reduce the application's 102 resource usage. Note that even if the actual resource usage is less than the allowed usage, the scheduler 106 may continue to throttle the application's activities. The application 102 may be under control only because of the throttling currently in effect. If the current usage is substantially less than the allowed level, then the scheduler 102 can relax the throttling somewhat. The scheduler 102 continues this practice until the current application usage is in the same range as the allowed usage.

For example, if the indexing engine has a target allocation of 5% CPU usage, but has a CPU usage of 14% over the monitor window, then the scheduler 106 takes one or more actions intended to drive the indexing engine's CPU usage down to 5% over some selected time window. The selected time window is the monitor window, in one embodiment. Further details of taking an action to enforce the policy 104 are described below. Briefly, some examples include changing process priority, putting a process to sleep, and stopping a process.

After taking the action, control passes to step 208 to learn the actual resource usage by the application 102. Steps 208-212 are performed until resource usage complies with the policy 104. Thus, the scheduler 106 uses feedback to control the application's 102 resource usage to enforce the policy 104.

### Example Actions to Enforce the Policies

As previously discussed, if the resource usage for a particular application 102 is above the applicable limit, then the scheduler 106 takes one or more actions to reduce the resource usage. The following discussion includes several actions for enforcing the resource allocation.

Some resources, such as resident memory, are directly controllable. For such directly controllable resources, the scheduler 106 may use operating system primitives 126 to limit the usage of the application 102. For example, the scheduler 106 asks the operating system to enforce the memory usage of the indexing engine.

In cases of resources which cannot be controlled directly, the scheduler 106 takes other actions to enforce the limits. For certain resources, the application's 102 usage can be measured on a per-activity 110 basis. For instance, in case of CPU limits, the scheduler 106 can learn of the usage per thread and per process. Therefore, the scheduler 106 may lower the process' and threads' priority to attempt to bring down CPU usage. To reduce the priority, the scheduler 106 may use operating system primitives 126 to request that the operating system lower the priority of one or more threads or processes of the application 102.

In the collaborative mode, the activities 110 check with the scheduler 106 periodically for permission to proceed. The scheduler 106 suspends the activities 110 as required to bring down the usage to under the limit. For example, the scheduler 106 puts the activity 110 to sleep. The length of time of the suspension is estimated based on the activity's 110 urgency, its past resource usage, and the current resource limit. Collaborative mode can be used to control CPU usage, as well as other resources such as disk IO or network IO. Controlling disk IO or network IO can be achieved by either centralizing or intercepting all IO calls from the application 102 and channeling these calls through the scheduler 106.

The computation is refined by feedback until the application's 102 resource usage comes below the limit. In one embodiment, the feedback computations may refine resource allocations to specific individual activities in order to control the application's usage. In another embodiment, the feedback loop is used to refine the current allowed application resource limit which is then shared out to the activities (as per their urgencies).

In the collaborative mode, the scheduler 106 knows the urgency of the activity 110 being executed by the process/thread. The scheduler 106 throttles low urgency activities 110 much more than high urgency activities, in one embodiment. For example, consider an application 102 that is allowed 30% CPU usage and has a high, a medium, and a low urgency activity 110. The scheduler 106 might reduce the CPU usage of the high urgency activity 110 to 20%, the medium to 8%, and the low to 2%. These values are provided for illustrative purposes.

While initially the allowed resource usage is directly apportioned to the application's activities according to their urgencies, during subsequent cycles it is the feedback mechanism which controls the resource apportioned to each activity, in an embodiment. The scheduler 106 keeps track of the recent history of how much resource allocation each activity was allowed in the past, and how much the application 102 ended up using in that time window. This helps the scheduler 106 to refine the allocation so that the overall application resource usage is brought to control. This is useful in at least two cases.

A first case is when there are uncontrolled threads/processes in the application 102. That is, threads/processes that cannot be directly controlled by the scheduler 106, but which share a master-slave relationship with one of the activities which is controllable by the scheduler 106. Then, throttling the master also results in throttling the slaves, and the level of throttling is determined be feedback mechanism based on past behavior.

A second case is when the resource is controlled by a proxy resource. For instance, when disk I/O is being controlled by means of controlling CPU allocation. Again, it is the feedback mechanism which helps the scheduler 106 determines the CPU limits per activity which results in the overall application disk I/O being maintained within limits.

In some cases, not all the processes/threads collaborate with the scheduler 106. That is, an application 102 that does collaborate with the scheduler 106 may invoke a process external to the application, wherein the external process does not collaborate with the scheduler. Thus, the external process does not make calls to the scheduler to get permission to execute. In this case, the scheduler 106 is not able to directly control the external process order to limit its resource usage. However, the master-slave relationship between the application 102 and the external process allows the scheduler 106 to control resource usage. For example, the indexing engine might invoke a process external to the indexing engine in order to tokenize documents. However, this external process might not be directly controllable by the scheduler 106. However, the scheduler 106 can take an action such as putting the indexing engine to sleep or reducing its priority in order to reduce resource usage of the external process.

In one embodiment, the scheduler 106 stops the activity 110 for a period of time and then re-starts it in order to limit resource usage. This technique is typically only used in cases in which the battery is low because of the overhead of having to re-start the activity 110.

When certain events occur it may be difficult to effectively control resource usage using some of the foregoing techniques. The scheduler 106 may suspend/resume the application 102 as a whole, in response to such events. For instance, if a laptop is going to battery mode, or if free disk space runs very low, the scheduler 106 may suspend the application 102 altogether. The application 102 may be resumed when the system returns to AC power or when disk is cleaned to get more disk space.

The scheduler 106 may use a controllable resource as a proxy to limit usage of a resource which cannot be directly controlled. For example, the scheduler 106 may not be able to directly control network I/O usage to enforce a policy for a download manager. However, the scheduler 106 can limit CPU usage of the download manager until the network I/O usage limits are complied with.

### Scaling the Resource Allocation Based on Aggregation of Activities

In one embodiment, the scheduler 106 scales down the maximum allowed resource usage based on factors such as how many activities an application 102 currently has running and their respective urgencies. For example, in the IDLE state the indexing engine is allowed a maximum of 50% CPU usage. That is, the combined CPU usage of all of the activities of the indexing engine must be no more than 50%. In this embodiment, the 50% value is scaled down based on how many activities the indexing engine currently has running and the respective urgencies of the activities. In general, fewer activities and lower urgencies will result in scaling down further. The following example is provided to illustrate how the scheduler 106 might scale.

The urgencies might be classified as high, medium, low, and very low. Each urgency is assigned a weight such as 50, 25, 10, 5. The weights of each running activity 110 are combined. Based on the combined weight, the allowed usage is scaled. For example, if the combined weight is 100 or greater, then no scaling is performed. If the combined weight is less than 100, then the combined weight, as represented as a percentage, is used as a scaling factor.

For illustrative purposes, consider the following two example cases. Case 1: The indexing engine has two high urgency activities running, resulting in combined weight of 100.No scaling is performed for Case 1. Case 2: The indexing engine has one medium urgency activity 110 and one low urgency activity 110 running, resulting on a combined weight of 35. The allowed usage is scaled down to 35% of the maximum that is defined in the policy 104. Clearly, many other techniques could be used to scale down the allowed resource usage.

### Application Changing its Urgency

In one embodiment, an application 102 dynamically adapts the urgency assigned to one or more of its activities 110. As previously discussed, the scheduler 106 may use the urgency to determine how to enforce the policies. In some cases, the application 102 alters its urgency based on the tasks it has to perform and/or conditions in the computer system. The following examples of applications 102 altering their urgencies are provided for illustration. A desktop indexing engine may run at high urgency during the initial round of indexing and may lower its urgency when subsequently optimizing indexes or scanning for further changes. A disk defragmentation daemon may run at a low urgency immediately after a full scan that indicated that defragmentation would result in minimal benefit, but may increase its urgency if it detects significant disk activity 110.

The application 102 can change its urgency in response to a user request. For example, a download/synchronization manager may normally run at a low urgency, but may increase its urgency in response to a user request to “synchronize now” in which case it may run at high urgency.

### Hardware Overview

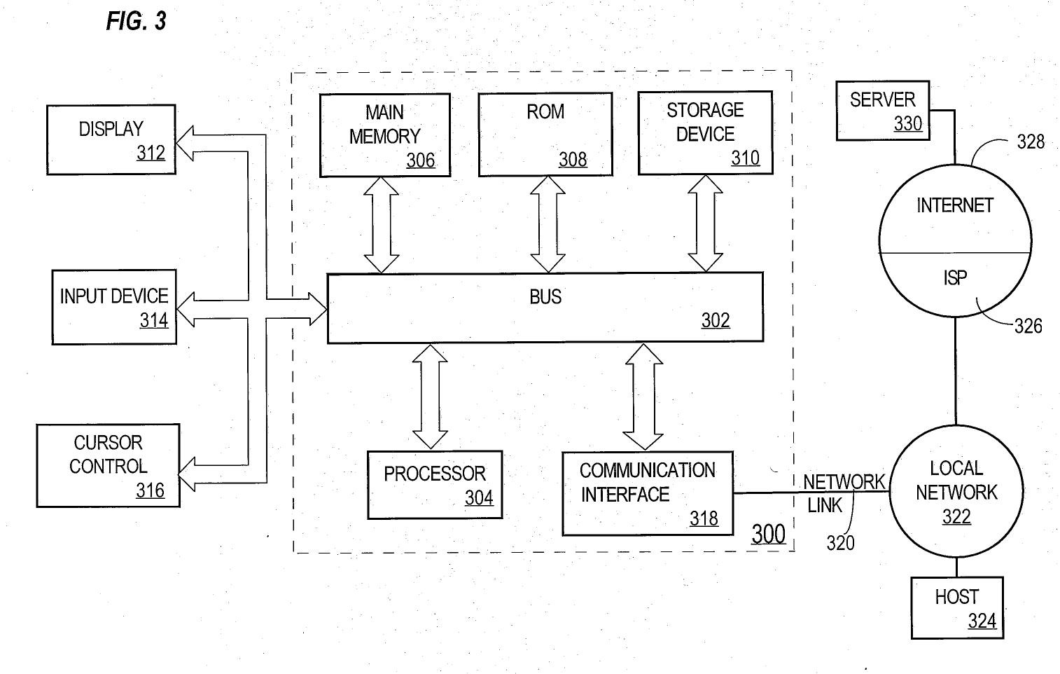

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of scheduling in a computer system, comprising:
monitoring one or more conditions of the computer system;
based on the one or more conditions and a policy associated with an application, determining a maximum allowed usage of a particular resource by the application;
determining whether actual usage of the particular resource by the application is greater than the maximum allowed usage; and
in response to determining that the actual resource usage is greater than the maximum allowed usage, performing one or more actions to reduce the actual resource usage until the actual resource usage is at or below the maximum allowed usage.

2. The method of claim 1, wherein performing one or more actions includes changing a scheduling priority of an activity of the application.

3. The method of claim 1, wherein performing one or more actions includes controlling execution of the application in order to reduce usage of the particular resource by the application.

4. The method of claim 1, wherein:
the actual usage of the particular resource by the application includes usage of the particular resource by a process external to the application that the application invokes; and
performing one or more actions includes controlling execution of the application in order to reduce usage of the particular resource by the process external to the application.

5. The method of claim 1, wherein performing one or more actions includes controlling usage of another resource by the application in order to reduce usage of the particular resource by the application.

6. The method of claim 1, wherein the application is divided into one or more activities that each have a specified urgency, and determining the maximum allowed usage is based on the urgency of each of the activities that is currently running.

7. The method of claim 6, further comprising the application altering an urgency of one or more of its activities.

8. The method of claim 1, further comprising:
based on user input, establishing the maximum allowed usage for the particular resource by the application for a state of the computer system.

9. The method of claim 1, further comprising:
based on user input, determining a value for a condition of the computer system that defines a state of the computer system, wherein the maximum allowed usage is based on the state.

10. A computer readable storage medium comprising instructions which when executed on a processor cause the processor to execute the steps of:
monitoring one or more conditions of the computer system;
based on the one or more conditions and a policy associated with an application, determining a maximum allowed usage of a particular resource by the application;
determining whether actual usage of the particular resource by the application is greater than the maximum allowed usage; and
in response to determining that the actual resource usage is greater than the maximum allowed usage, performing one or more actions to reduce the actual resource usage until the actual resource usage is at or below the maximum allowed usage.

11. The computer readable storage medium of claim 10, wherein the instructions which when executed on the processor cause the processor to execute the step of performing one or more actions includes instructions which when executed on the processor cause the processor to execute the step of changing a scheduling priority of an activity of the application.

12. The computer readable storage medium of claim 10, wherein the instructions which when executed on the processor cause the processor to execute the step of performing one or more actions includes instructions which when executed on the processor cause the processor to execute the step of controlling execution of the application in order to reduce usage of the particular resource by the application.

13. The computer readable storage medium of claim 10, wherein:
the actual usage of the particular resource by the application includes usage of the particular resource by a process external to the application that the application invokes; and
the instructions which when executed on the processor cause the processor to execute the step of performing one or more actions include instructions which when executed on the processor cause the processor to execute the step of controlling execution of the application in order to reduce usage of the particular resource by the process external to the application.

14. The computer readable storage medium of claim 10, wherein the instructions which when executed on the processor cause the processor to execute the step of performing one or more actions include instructions which when executed on the processor cause the processor to execute the step of controlling usage of another resource by the application in order to reduce usage of the particular resource by the application.

15. The computer readable storage medium of claim 10, wherein the application is divided into one or more activities that each have a specified urgency, and wherein the instructions which when executed on the processor cause the processor to execute the step of determining the maximum allowed usage include instructions which when executed on the processor cause the processor to execute the step of determining the maximum allowed usage based on the urgency of each of the activities that is currently running.

16. The computer readable storage medium of claim 15, further comprising instructions which when executed on the processor cause the processor to execute the step of the application altering an urgency of one or more of its activities.

17. The computer readable storage medium of claim 10, further comprising instructions which when executed on the processor cause the processor to execute the step of:
based on user input, establishing the maximum allowed usage for the particular resource by the application for a state of the computer system.

18. The computer readable storage medium of claim 10, further comprising instructions which when executed on the processor cause the processor to execute the step of:
based on user input, determining a value for a condition of the computer system that defines a state of the computer system, wherein the maximum allowed usage is based on the state.

19. A system comprising:
a processor; and
a computer readable storage medium coupled to the processor, the computer readable medium comprising instructions which when executed on a processor cause the processor to execute the steps of:
monitoring one or more conditions of the computer system;
based on the one or more conditions and a policy associated with an application, determining a maximum allowed usage of a particular resource by the application;
determining whether actual usage of the particular resource by the application is greater than the maximum allowed usage; and
in response to determining that the actual resource usage is greater than the maximum allowed usage, performing one or more actions to reduce the actual resource usage until the actual resource usage is at or below the maximum allowed usage.

20. The system of claim 19, wherein the instructions which when executed on the processor cause the processor to execute the step of performing one or more actions includes instructions which when executed on the processor cause the processor to execute the step of controlling execution of the application in order to reduce usage of the particular resource by the application.
